(19) United States
(12) Patent Application Publication
(10) Pub. No.: US 2008/0013312 A1
(43) Pub. Date: Jan. 17, 2008

(54) Method for modulating warm color light

(75) Inventors: Chien-Jung Wu, Taipei Hsien (TW); Tsung-Ting Sun, Taipei Hsien (TW); Hung-Ta Liao, Taipei Hsien (TW); Tzu-Hsuan Yen, Taipei Hsien (TW)

Correspondence Address: BIRCH STEWART KOLASCH & BIRCH, PO BOX 747, FALLS CHURCH, VA, 22040-0747, US

(73) Assignee: EDISON OPTO CORPORATION

(21) Appl. No.: 11/638,525

(22) Filed: Dec. 14, 2006

(30) Foreign Application Priority Data
Jul. 14, 2006 (TW) 95125949

(51) Int. Cl. F21V 9/00

(52) U.S. Cl. 362/231

(57) ABSTRACT

A method for modulating warm color light here disclosed includes the steps of modulating a white light source for generating white light, setting at least one selected brightness-adjust Light Emitting Diode (LED) for generating modulated light, adjusting the brightness of the selected brightness-adjust LED, and mixing the white light and the modulated light after adjusting the brightness of the selected brightness-adjust LED, then to generate the warm color light.

### FIELD OF THE INVENTION

The present invention relates to a method for modulating colored light, and more particularly to a method for modulating warm color light by mixing white light and at least one kind of modulated light projected from at least one kind of selected brightness-adjust light emitting diode (LED) light source.

### BACKGROUND OF THE INVENTION

In the indoor ambient light design, various series of color lights are adopted according to different indoor environment. Due to the middle latitude zones and the low latitude zones, the latitudes of 22 to 25, are full of the sunshine, it is not suitable that the indoor ambient light design of such areas take a series of white color; otherwise the white color may be too bright for eyes.

Thus, in the middle latitude zones and the low latitude zones, it is better to use warm color light to serve as indoor ambient light, so that the techniques of modulating different kinds of warm color light are very important, and have more additional commercial value.

Some detail description for the techniques of modulating warm color light are as follows. Please refer to FIG. 1, which is a block diagram illustrating a warm color light modulating system provided in accordance with a prior art. As shown in FIG. 1, a warm color light modulating system 1 includes a blue LED 11 and yellow phosphor 12, wherein a series of optical reactions are stimulated to project white light serving as a white light source 13 when blue light is projected from the blue LED 11 to pass through the yellow phosphor 12. The color temperature and the brightness of the white light projected from the white light source 13 can be adjusted through the ways of adjusting the brightness of the blue light projected from the blue LED light source 11 and selecting different kinds of the yellow phosphor 12.

Meanwhile, the warm color light modulating system 1 further includes red phosphor 14. Another series of optical reactions are stimulated to project warm color light 15 when the white light is projected from the white light source 13 to passing through the red phosphor 14. The color of the warm color light 15 can be modulated by the ways of selecting different kinds of the red phosphor 14 or being back to adjust the color temperature and the brightness of the white light.

However, people skilled in the related arts can easily realize that the light energy is reduced once a light progresses any series of optical reaction with the phosphor, while in the prior art as disclosed above, it is necessary for that the blue light projected from the blue LED 11 may be progressed two series of optical reactions when it passes the two colors of the phosphor, including the series of optical reactions with the yellow phosphor 12 and the other series of optical reactions with the red phosphor 14, so that the lighting energy is reduced twice, and the illumination of light is reduced with the reduction of the light energy.

Additionally, it is necessary to adjust the color of the warm color light 15 through selecting different kinds of the red phosphor 14 or being back to adjust the color temperature and the brightness of the white light, so that it is very inconvenient for the adjustment, and the effect is usually not as well as requested.

### SUMMARY OF THE INVENTION

The problems intended being solved in the present invention and the objects of the present invention are described as follows:
Making a summary from above description for the warm color modulating techniques, there are two main problems existing. One of them is that the blue light is necessary to progress an additional series of optical reactions, so that the illumination of light will be reduced at the same time, and the other one is that the warm color light is not easily to be adjusted and the effect is not as well as requested.

Accordingly, the primary object of the present invention provides a method for modulating warm color light through the idea of reducing progressing optical reactions between light and phosphor, and replacing by providing additional modulated light for directly mixing with the white light in order to modulate and produce the warm color light, so the object of the reducing progressing optical reactions between the light and the phosphor can be carried out.

The secondary object of the present invention provides the method for modulating the warm color light, the method uses the different kinds of modulated lights generated and adjusted from the selected brightness-adjust light sources to mix with the white light, then to modulate the warm color light. Furthermore, the more sorts of brightness of the selected brightness-adjust light sources can be adjusted again according to the previous modulated warm color light, so that the more different kinds of suitable modulated light can be generated for mixing the white light to get more different kinds of suitable warm color light.

Another object of the present invention is providing a method for modulating the warm color light, wherein the different kinds of the warm color lights can be gotten through adjusting the brightness of the modulated light sources to generate the different kinds of suitable modulated lights, and mixing the different kinds of suitable modulated lights with the white light, so that the user can modulate the different kinds of the most suitable warm color light according to the variation of the environment.

Means of the present invention for solving problems:
Means of the present invention for solving the problems as mentioned above is providing a method for modulating the warm color light. The method comprises the steps of modulating a white light source for projecting white light, setting at least one selected brightness-adjust LED for projecting modulated light, and mixing the white light and the modulated light generated after adjusting the brightness of the selected brightness-adjust LED, then to generate the warm color light.

In a preferred embodiment of the present invention, in order to carry out the skill of modulating the warm color light, the wavelength of the modulated light is between 580 nm and 660 nm and distributed in the color band of the amber zone and the red zone.

Effects of the present invention with respect to prior arts:
Making a comparison with the prior arts from above description, the method for modulating the warm color light provided in the present invention not only can effectively reduce the problem of light effect lose caused by illumination reduction, but also can directly modulate the different kinds of modulated lights via adjusting the brightness of the selected modulated light sources, and mixing the different kinds of modulated lights with the white light, then to directly adjust the color of the warm color light. Meanwhile, through using the method for modulating the warm color light provided in the present invention, any user can directly modulate the most suitable warm color light according to the actual variation of the environment.

The devices, characteristics, and the best embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram illustrating a warm color light modulating system provided in accordance with prior arts;

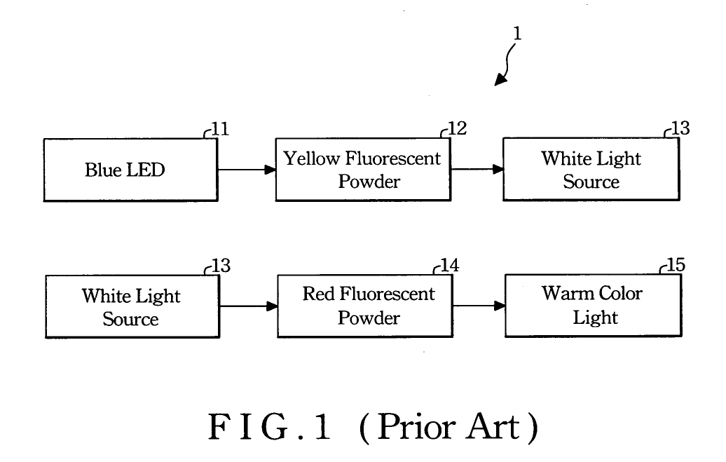

FIG. 2 is a block diagram illustrating a warm color light modulating system provided in accordance with a preferred embodiment of the present invention;

FIG. 3 is a flowchart illustrating the preferred embodiment of the present invention;

FIG. 4 is a projected graph illustrating a visible-color-light graph projected on an X-Y plane of a color-coordinate;

FIG. 5 is a projected graph illustrating the variation relation of white light projected from a white light source, the projected graph on the X-Y plane of the color-coordinate is provided in accordance with the preferred embodiment of the present invention; and

FIG. 6 is a projecting graph on an X-Y plane of a color-coordinate illustrating the variation relation of the warm color light after modulating the modulated light and the white light, in accordance with the preferred embodiment of the present invention.

### DETAILED DESCRIPTION OF THE PREFERRED EMBODIMENTS

Due to that the method for modulating warm color light as provided in accordance with the present invention can be widely applied to many kinds of lamp assemblies, the combined applications are too numerous to be enumerated and described so as to disclose a preferred embodiment and two applications only.

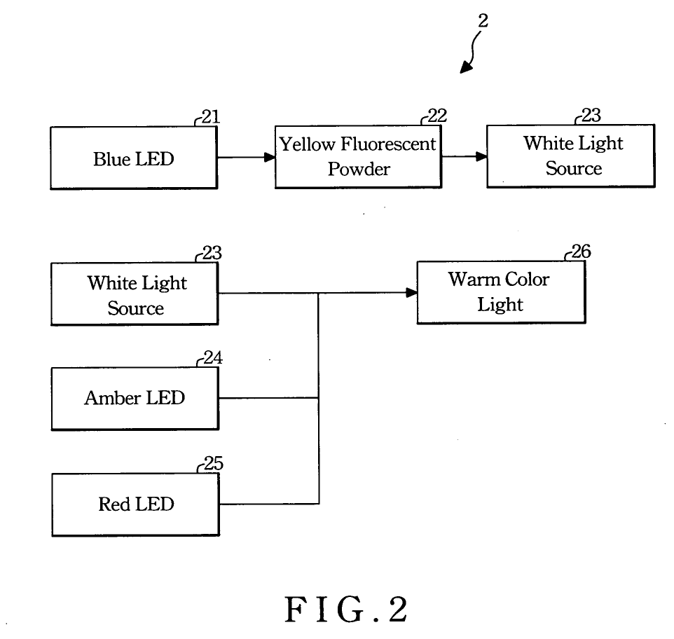

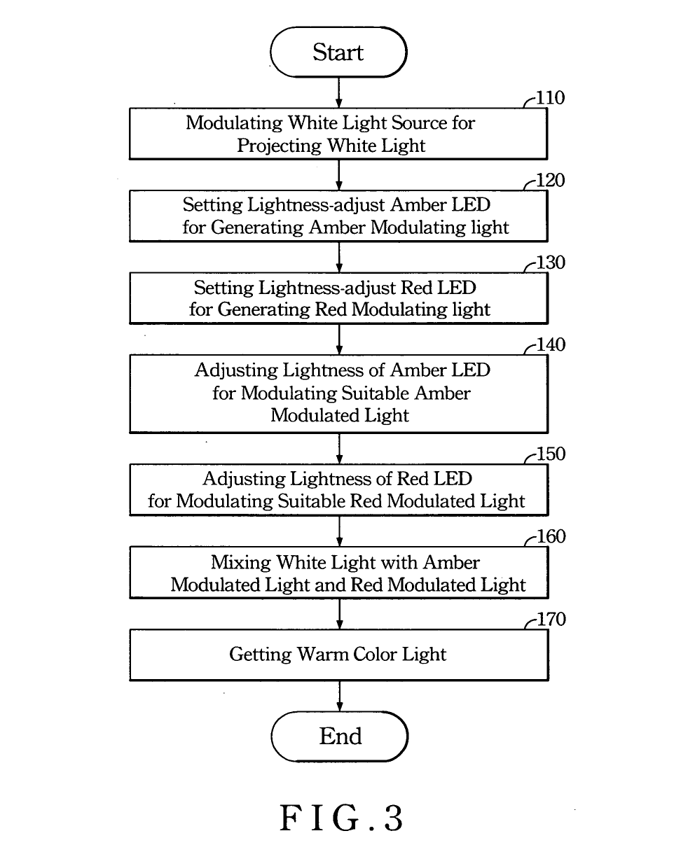

Please refer to FIG. 2 and FIG. 3, where FIG. 2 is a block diagram illustrating a warm color light modulating system provided in accordance with a preferred embodiment of the present invention, and FIG. 3 is a flowchart illustrating the preferred embodiment of the present invention. As shown in the figures, a warm color light modulating system 2 includes a blue LED 21 and yellow phosphor 22, wherein a series of optical reactions are stimulated to generate white light served as a white light source 23 when blue light projected from the blue LED 21 passes through the yellow phosphor 22. The color temperature and the brightness of the white light projected from the white light source 23 can be adjusted through the ways of adjusting the brightness of the blue light projected from the blue LED 21 and selecting different yellow phosphor 22.

Meanwhile, the warm color light modulating system 2 further includes two brightness-adjust LEDs, i.e., an amber LED 24 and a red LED 25, wherein the amber LED 24 can generate modulated amber light and the red LED 25 can generate modulated red light. The white light projected from the white light source 23, after its brightness has been adjusted according to either one of the ways, will go on mixing with the modulated amber light and the modulated red light to produce warm color light 26.

Making a summary according to above description, the operation flowchart in accordance with the preferred embodiment of the present invention is shown in FIG. 3. Please refer to FIG. 2 and FIG. 3, where illustrate the preferred embodiment of the present invention includes the steps of modulating the white light source 22 for projecting the white light (step 110), setting the brightness of the brightness-adjust LED for generating modulated light, i.e., setting the amber LED 24 for generating the modulated amber light (step 120) and setting the red LED for generating the modulated red light (step 130), adjusting the brightness of the amber LED 24 for modulating suitable modulated amber light (step 140), adjusting the brightness of the red LED 25 for modulating suitable modulated red light (step 150), mixing the white light with the modulated amber light and the modulated red light (step 160), and finally producing the warm color light (step 170).

People skilled in the related arts can easily realize that among the steps as mentioned above, the method is mixing the white light with the modulated amber light and the modulated red light to produce the warm color light after the modulated amber light and the modulated red light have been suitably modulated. While, the amber LED 24 and the red LED 25 can be adjusted again to modulate more suitable warm color light 26 when the warm color light 26 modulated is out of user's expectation. Besides, the steps of 120 to 150 can be adjusted in other variations, such as, operating these steps in the turn of step 130, step 150, step 120, and step 140.

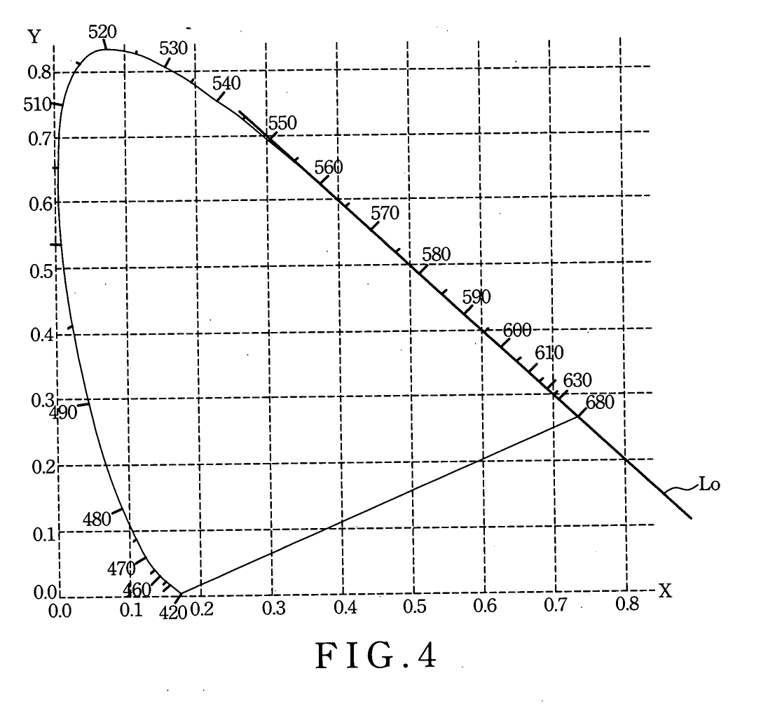

In the following figures, from FIG. 4 to FIG. 6, the preferred embodiment will be illustrated in projected graphs on an X-Y plane of a color-coordinate, and two applications in accordance with the present invention will also be explained through these projecting graphs. Please refer to FIG. 4, which is a projecting graph illustrating a visible-color-light graph projected on the X-Y plane of the color-coordinate. As shown in FIG. 4, the location marked with a number “420” represents the wavelength of 420 nm, the location marked with a number “680” represents the wavelength of 680 nm, and the locations marked with “420” and “680” respectively are linked by a line and a curved line to form a closed region, which all kinds of visible light are located therein.

Along the curved line, all numbers are marked to represent the wavelength in nm with respect to the numbers. From FIG. 4, the curved line with the wavelength range between 560 nm and 680 nm is approximate to an approaching line L0 with the equation of X+Y=1 on the X-Y plane built by X axis and Y axis.

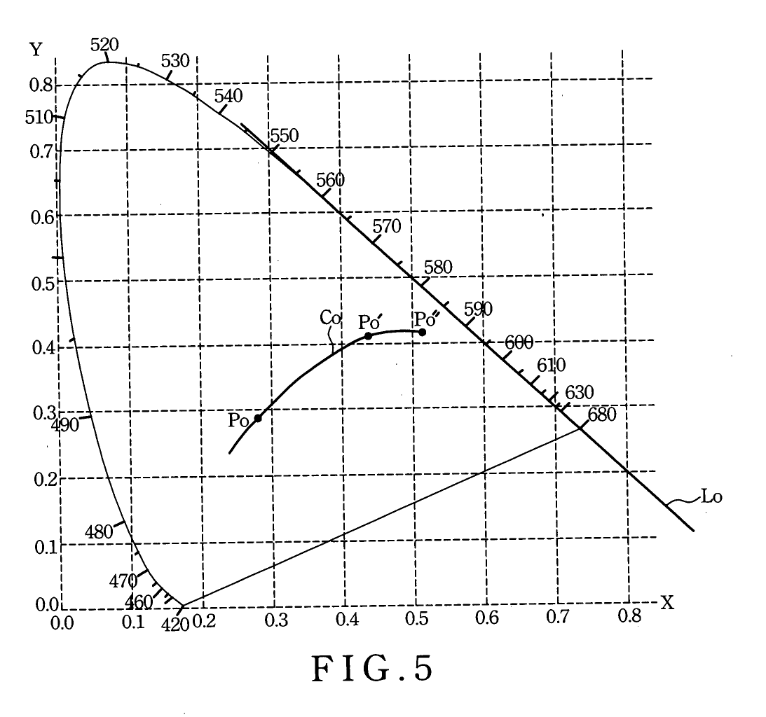

Please refer to FIG. 5, which is a projected graph illustrating the variation relation of white light projected from a white light source, the projected graph on the X-Y plane of the color-coordinate is provided in accordance with the preferred embodiment of the present invention. As shown in FIG. 5, the location of the white light as mentioned in step 110 varies along a white light curved line C0 when it is adjusted by any user, wherein when the location is located on a white light point P0 with a coordinate location approximate to (0.28, 0.29), the color temperature of the white light is 10000K; when the location is located on another white light point P0′ with a coordinate location approximate to (0.44, 0.41), the color temperature of the white light is 3000K; when the location is located on another white light point P0″ with a coordinate location approximate to (0.525, 0.415), the color temperature of the white light is 2000K. In the preferred embodiment of the present invention, the white light is suggested to be controlled in the color temperature range between 4000K and 10000K.

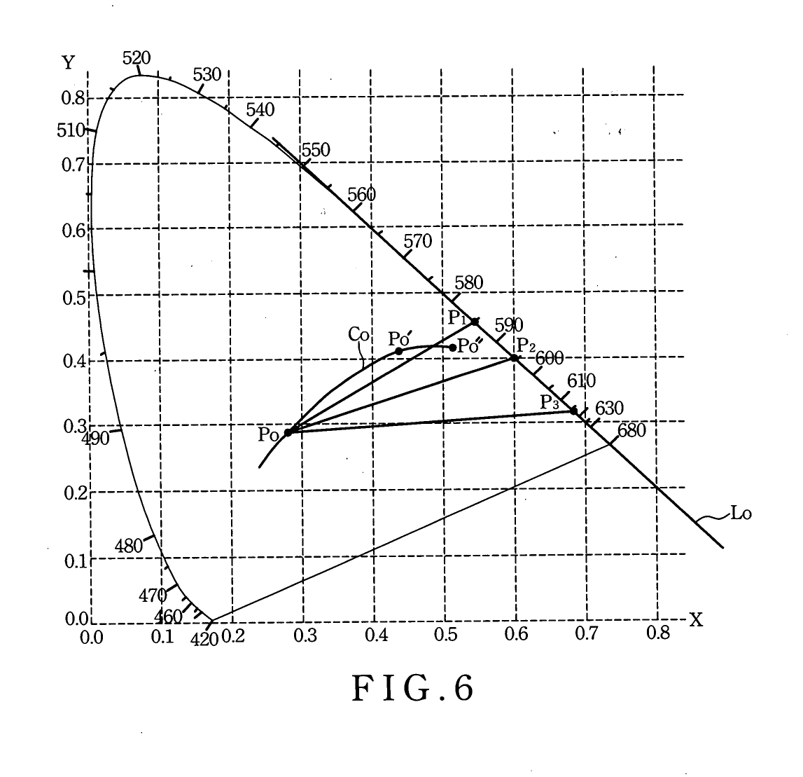

With reference to FIG. 6, which is a projecting graph on an X-Y plane of a color-coordinate illustrating the variation relation of the warm color light after modulating the modulated light and the white light, in accordance with the preferred embodiment of the present invention, and FIG. 2 simultaneously. As shown in the figures, in the preferred embodiment of the present invention, the white light with the color temperature of 10000K, and the different kinds of the modulated light with the wavelength range between 580 nm and 660 nm are mixed to produce the warm color light 26.

In a first application of the preferred embodiment of the present invention, the warm color 26 is modulated by mixing the white light with the color temperature of 10000K, the modulated amber light with the wavelength of 585 nm and the modulated red light with the wavelength of 620 nm, wherein the modulated amber light with the wavelength of 585 nm is located on a modulated amber light point P1 with a coordinate location approximate to (0.55, 0.45), the modulated red light with the wavelength of 620 nm is located on a modulated red light point P3 with a coordinate location approximate to (0.68, 0.32). When the user adjusts the brightness of the white light source 23, the amber LED 24 and the red LED 25 to respectively modulate variable types of brightness of the white light with the color temperature of 10000K, the modulated amber light with the wavelength of 585 nm and the modulated red light with the wavelength of 620 nm, the warm color light 26 will be varied within a region formed by lining the white light point P0, the modulated amber light point P1, and the modulated red light point P3.

In a second application of the preferred embodiment of the present invention, the warm color light 26 is modulated by mixing the white light with the color temperature of 10000K and the modulated amber light with the wavelength of 595 nm (the red LED 25 is turned off to stop generating the modulated red light), wherein the modulated amber light with the wavelength of 595 nm is located on a modulated amber light point P2 with a coordinate location approximate to (0.6, 0.4). When the user adjusts the brightness of the white light source 23 and the amber LED 24 to respectively modulate variable types of brightness of the white light with the color temperature of 10000K and the modulated amber light with the wavelength of 595 nm, the warm color light 26 will be varied within a line formed by lining the white light point P0 and the modulated amber light point P2.

From above description, with the comparison between the present invention and the prior arts, the present invention not only can effectively solve the problems of the decrease of the illumination but also can directly adjust the brightness of the light sources for modulating the modulated lights, such as the amber modulated light with the wavelength of 585 nm, the amber modulated light with the wavelength of 595 nm and the red modulated light with the wavelength of 620 nm, to be mixed with the white light then generate the warm color light. Meanwhile, in the real application, the warm color light modulating system 2 is capable of optionally providing with a brightness adjustment device for adjusting the brightness of the blue LED 21, the amber LED 24 and the red LED 25, thus the user can directly modulate the most comfortable warm color light 26 according to the requirement with respect of the real variation of the environment.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for modulating warm color light comprising the steps of:
(a) modulating a white light source for generating white light;
(b) setting at least one selected brightness-adjust Light Emitting Diode (LED) for generating modulated light; and
(c) mixing the white light and the modulated light to produce warm color light.

2. The method for modulating the warm color light as claimed in claim 1, wherein the white light of the step (a) is modulated by blue light projected from a blue LED light source and passing through yellow phosphor.

3. The method for modulating the warm color light as claimed in claim 2, wherein the wavelength of the blue light is between 440 nm and 480 nm.

4. The method for modulating the warm color light as claimed in claim 2, wherein the color temperature of white light is between 4000 K and 10000 K.

5. The method for modulating the warm color light as claimed in claim 1, wherein the step (b) further comprises the step (b1) of adjusting the brightness of the selected brightness-adjust LED light source.

6. The method for modulating the warm color light as claimed in claim 1, wherein the step (c) further comprises the step (c1) of adjusting the selected brightness-adjust LED light source again according to the modulated warm color.

7. The method for modulating the warm color light as claimed in claim 6, wherein the wavelength of the modulated light is between 580 nm and 660 nm.

8. The method for modulating the warm color light as claimed in claim 7, wherein the modulated light is amber light with the wavelength of 585 nm.

9. The method for modulating the warm color light as claimed in claim 7, wherein the modulated light is amber light with the wavelength of 595 nm.

10. The method for modulating the warm color light as claimed in claim 7, wherein the modulated light is red light with the wavelength of 620 nm.
